(19) United States
(12) Patent Application Publication
(10) Pub. No.: US 2011/0131224 A1
(43) Pub. Date: Jun. 2, 2011

(54) Methods for Creating a Recommended Device List from Metrics

(75) Inventors: William K. Bodin, Austin, TX (US); David Jaramillo, Boca Raton, FL (US); Derral C. Thorson, Austin, TX (US)

(73) Assignee: International Business Machines Corporation, Armonk, NY (US)

(21) Appl. No.: 12/629,792

(22) Filed: Dec. 2, 2009

(51) Int. Cl. G06F 17/30

(52) U.S. Cl. 707/758; 707/825; 707/E17.005

(57) ABSTRACT

An embodiment of the invention provides a method for creating a recommended device list from metrics. Device metrics of a plurality of mobile devices are accumulated, wherein the device metrics include device attributes of the mobile devices. The device attributes include user tags and/or user quality ratings of the mobile devices. A database of the mobile devices is created, wherein the database includes the device attributes. A request for a mobile device is received from a user, wherein the request includes user attributes. The user attributes include job responsibilities, job level, business unit, geographic location, and/or user affiliations. A processor matches the device attributes to the user attributes in order to generate a recommended device list. The recommended device list is sent to the user and/or an interface.

### FIELD OF THE INVENTION

The present invention is in the field of methods, systems, and computer program products for creating a recommended device list from metrics.

### SUMMARY

An embodiment of the invention includes a method for creating a recommended device list from metrics. More specifically, device metrics of a plurality of mobile devices are accumulated, wherein the device metrics include device attributes of the mobile devices. Device attributes for a newly available mobile device and/or a mobile device satisfying a predetermined level of popularity are also obtained. The device attributes include media format capabilities, codec types, operating system, Bluetooth capabilities, speakerphone capabilities, processing speed, signal strength, screen size, screen resolution, keyboard features, compatible web applications, compatible mobile applications, business affiliations, business unit affiliations, and/or cost. The device attributes also include user tags and/or user quality ratings of the mobile devices.

A database of the mobile devices is created, wherein the database includes the device attributes. A request for a mobile device is received from a user, wherein the request includes user attributes. The user attributes include job responsibilities, job level, business unit, geographic location, and/or user affiliations.

A processor matches the device attributes to the user attributes in order to generate a recommended device list. Specifically, for each mobile device in the database, the processor assigns an attribute score to at least one device attribute based on whether the device attribute matches a user attribute. A matching score is assigned to the mobile device based on the total attribute scores for device attributes.

The recommended device list is generated by ranking the mobile devices based on the matching score. In at least one embodiment, the recommended device list only includes mobile devices that have a matching score above a predetermined threshold. The recommended device list is verified to confirm that the device attributes of mobile devices are correct; and, the recommended device list is sent to the user and/or an interface.

In at least one embodiment of the invention, the user attributes are matched to service provider attributes to create a recommended service provider list. The service provider attributes include at least one of usage restrictions, coverage area, bundling packages, voicemail capabilities, data capabilities, group rates, and/or cost. The recommended service provider list is sent to the user and/or an interface.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for creating a recommended device list according to an embodiment of the invention;

FIG. 2 illustrates a system for creating a recommended device list according to an embodiment of the invention; and

FIG. 3 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a method for providing dependable and high quality voice and data services to users of mobile devices by building a dynamic repository of mobile devices and their respective attributes. The repository (also referred to herein as the “database”) is used to generate a recommended device list that is delivered to the user. The method determines, stores, and posts to a greater network, details relating to a list of mobile devices which are optimized to a user's job role, responsibilities, geographic or regional location, and/or special needs.

At least one embodiment of the invention functions within the context of a social networking system, in which users can search for and download mobile applications and web applications. For example, employees of a business organization can access mobile and web applications that are recommended by their employer. Thus, the social networking system can interface into a particular corporate managed plan (CMP).

An embodiment of the invention assists users in choosing an appropriate mobile device, service provider, and/or voice/data plan, based on the real-time, real-world collection of metrics related to these options. The metrics (also referred to herein as “attributes”) can include, for example, quality of service, user satisfaction data gathered on mobile devices at the time of application invocation and after application use, and/or granular data indicative of the device platform (e.g., operating system, memory capacity, Bluetooth, speakerphone, media capable (CODEC granular)). A core decision engine (also referred to herein as the processor or means for matching the device attributes to the user attributes) aggregates and processes the metrics to deliver a recommendation to the user.

At least one embodiment includes a method for creating a recommended device list wherein a user is associated with a particular job role and business unit within Company X. The user's business unit utilizes Media Library Y as a centralized repository for media assets (i.e., mobile and web applications) that the Company X considers relevant for its employees. The assets in the Media Library Y have a certain format or multiple formats, such as, for example, mp3, MPEG4, and Windows Media Video. The mobile devices also have a particular finite set of capabilities, which ultimately impacts the productivity of the user. The intersection of these areas is the common ground that the method addresses. By providing an automated analysis of a user's business unit, job role, job responsibilities and other user related metrics, in addition to the media types that the business unit utilizes, an impedance match (i.e., range of compatibility) is created between the user, the scope of assets, and the mobile device over in which these assets can be favorably and most completely experienced.

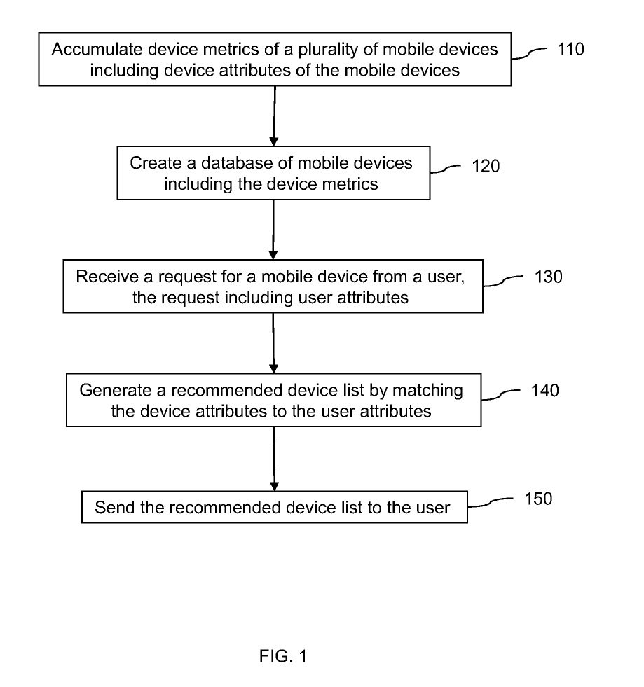

FIG. 1 is a flow diagram illustrating a method for creating a recommended device list according to an embodiment of the invention. A monitoring module (or means for accumulating device metrics) accumulates device metrics of a plurality of mobile devices, wherein the device metrics include device attributes of the mobile devices (110). In one example, the monitoring module accumulates device metrics of all mobile devices being serviced by service provider X. In another example, the monitoring module accumulates device metrics of all mobile devices owned by company Y. In at least one embodiment, the monitoring module obtains the device attributes from the manufacturers of the devices (e.g., Nokia™), device retailers (e.g., Best Buy™), and/or telecommunications service providers (e.g., Verizon Wireless™).

In at least one embodiment of the invention, the monitoring module obtains device attributes for newly available mobile devices and/or mobile devices satisfying a predetermined level of popularity (e.g., as set by a user and/or system administrator). For example, as described more fully below, user tags and/or user quality ratings are utilized to determine the popularity of a mobile device. When a mobile device reaches a predetermined level of popularity (e.g., more than 100 user tags), the monitoring module obtains device attributes of the mobile device.

In at least one embodiment of the invention, the device attributes include media format capabilities, codec types, operating system, Bluetooth capabilities, speakerphone capabilities, processing speed, signal strength, screen size, screen resolution, keyboard features (e.g., QWERTY keyboard, touch screen), camera/video capabilities, global positioning system (GPS) capabilities, and/or cost of the mobile device. In another embodiment, the device attributes include compatible web applications (i.e., a list of web applications that a particular mobile device is capable of running) and/or compatible mobile applications (i.e., a list of mobile applications that a particular mobile device is capable of running) In yet another embodiment, the device attributes include business affiliations of the mobile device (e.g., 50% of the employees at company X utilize mobile device Y) and/or business unit affiliations of the mobile device (e.g., 2% of the employees in the accounting division utilize mobile device Z).

In at least one embodiment of the invention, the device attributes include the number and type of user tags and/or an aggregate of user quality ratings of the mobile devices. More specifically, users who recommend a particular asset electronically mark/label the recommended asset with a user tag. In another embodiment, the user tags are associated with assets that are not recommended by users. In yet another embodiment, the net positive or negative value of the total combined user tags is used, e.g., if an asset has 87 positive user tags and 71 negative user tags, the asset has a positive user tag value of 16.

The user quality ratings include, for example, a five-star rating system, a numerical rating system, an alphabetical grading system, and/or binary scoring system (e.g., a thumbs up/down system). In at least one embodiment, user quality ratings of mobile devices are gathered from multiple sources having different grading systems, wherein a uniform rating system for the mobile devices is created based on the scores from the different grading systems. In at least one embodiment, the monitoring module obtains the user tags and/or user quality rating metrics from the manufacturers of the devices, device retailers, and/or telecommunications service providers. A database of the mobile devices (or means for storing a list of the mobile devices) is created, wherein the database includes the device metrics accumulated by the monitoring module (120). In another embodiment, the method maintains and updates an existing database of mobile devices and device metrics.

A request for a mobile device is received from a user, wherein the request includes user attributes (130). In at least one embodiment, the user attributes are manually entered by the user and/or an employee of the user's company via a graphic user interface. In another embodiment, the user attributes are automatically retrieved from a company database including employee profiles.

In at least one embodiment, the user attributes include the job responsibilities of the user (e.g., clerical, sales, accounting, IT support, level of travel, time percentage spent out of the office, level of telecommunicating) and/or job level of the user (e.g., senior management, supervisory, entry-level). In another embodiment, the user attributes include the user's business unit (e.g., human resources, marketing, copy center, research and development), the user's geographic location (e.g., office complex, city, state, time zone), and/or affiliations of the user (e.g., member of certain professional organizations or associations).

A processor generates a recommended device list by matching the device attributes to the user attributes (140). Matching is performed via database queries, indexing, sorting and/or filters. More specifically, in at least one embodiment, for each mobile device in the database, the processor assigns an attribute score to each device attribute of the mobile device. The attribute score is based on whether the device attribute matches a user attribute. For example, if mobile device A is capable of running mobile application X, and more than 90% of the employees in the user's business unit use mobile application X, then mobile device A is assigned an attribute score of 5. In another example, if a user is an entry-level sales representative in Boston, Mass., and 20% of the entry-level sales representatives in the northeastern United States utilize web application Y, then a mobile device B capable of running web application Y is assigned an attribute score of 1. In yet another example, if a user is employed in the delivery business unit, a mobile device C having Bluetooth capabilities is assigned an attribute score of 10.

In at least one embodiment, the attributes are weighted equally. For example, if a mobile device includes 2 device attributes in the database (signal strength and cost), then the device attributes are weighted equally (i.e., 50%, 50%). In another example, a mobile device includes 4 device attributes in the database: processing speed, screen size, keyboard features, and codec types. In this example, each of the device attributes are weighted 25%.

In another embodiment of the invention, different attributes and capabilities of the user and/or mobile devices are assigned different weights, as determined by the user and/or system administrator. For example, a system administrator considers a user's job responsibilities more important than a user's geographic location. As such, in this example of only two user attributes, the job responsibility user attribute is weighted 75% and the geographic location user attribute is weighted 25%. In another example, a user considers the processing speed of a mobile device more important than the screen size; and as such, the processing speed device attribute is weighted 60% and the screen size device attribute is weighted 40% when there are only two user attributes.

Accordingly, in at least one embodiment, the system administrator and/or user assigns different weights to the user attributes and/or device attributes. Therefore, the attribute scores of the mobile devices are dependent upon the respective weights given to the user attributes and device attributes.

A matching score is assigned to each mobile device by combining and/or averaging the attribute scores of their respective device attributes. For example, if mobile device X has 4 device attributes scores (2, 1, 0, 4) of equal weight (i.e., each device attribute being weighted 25%), then the total matching score of mobile device X is 7 (2+1+0+4) and the average matching score is 1.75 (7/4). In another example, if mobile device Y has 5 device attributes scores (0, 1, 5, 4, 1) of varying weight (40%, 20%, 20%, 10%, and 10%, respectively), then the total matching score of mobile device Y is 8.5 (0×(40/(100/5))+1×(20/(100/5))+5×(20/(100/5))+4×(10/(100/5))+1×(10/(100/5))) and the average matching score is 1.7 (8.5/7).

The recommended device list is generated by ranking the mobile devices based on their respective matching scores. In at least one embodiment, the recommended device list only includes mobile devices having a matching score above a predetermined threshold (e.g., as set by a user and/or system administrator). For example, the recommended device list will not include mobile devices having a total matching score of less than 5. In another embodiment, the recommended device list only includes mobile devices having attribute scores that meet a predetermined threshold. For example, the recommended device list will not include mobile devices having three attribute scores that have a value less than 2.

The recommended device list is sent to the user (150). In at least one embodiment, the recommended device list is sent to an interface (e.g., website and/or network database). Thus, for example, a user can go to the website to find mobile devices that are commonly used by mid-level accounting personnel employed by his company. In another embodiment, the user manually enters user attributes that do not match his or her profile. For example, if a user is considering a job offer at a higher level from another company in another state, he can receive a recommended device list based on those user attributes. In another example, a user who wants to recommend mobile devices to staff members that she is responsible for supervising, she can enter the appropriate user attributes to receive a recommended device list.

In yet another embodiment, the device attributes of the mobile devices in the recommended device list are confirmed to ensure accuracy. For example, if the user attributes include the job responsibility “delivery”, then the processor automatically reviews the device specifications for the mobile devices in the recommended device list to ensure that the mobile devices are capable of running a mobile application for “navigation” or “driving directions”. In another example, if the user attributes include the job responsibility “graphic artist”, then the processor ensures that the recommended mobile devices include a color screen.

Another embodiment of the invention further includes matching the user attributes to service provider attributes to create a recommended service provider list. The service provider attributes include usage restrictions, application downloads, media downloads, coverage area, bundling packages, voicemail capabilities, data capabilities, group rates, and/or cost. Thus, for example, a construction company in Montana looking for telecommunication services can receive a recommended list of service providers based on the size, location, and services offered by the company. As described above, the attributes can have varying weights as determined by the user and/or system administrator.

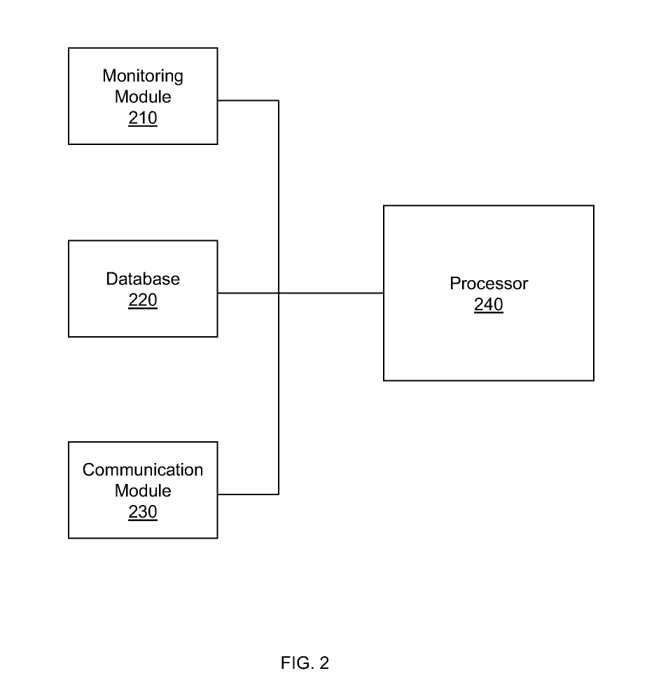

FIG. 2 illustrates a system for searching for mobile assets according to an embodiment of the invention. The system includes a monitoring module 210 for accumulating device metrics of a plurality of mobile devices, wherein the device metrics include device attributes of the mobile devices. In at least one embodiment, the monitoring module 210 includes an applet on the mobile device. The device attributes include media format capabilities, codec types, operating system, Bluetooth capabilities, speakerphone capabilities, processing speed, signal strength, screen size, screen resolution, keyboard features, compatible web applications, compatible mobile applications, business affiliations, business unit affiliations, cost, user tags and/or user quality ratings of the mobile devices.

The system further includes a database 220 of mobile devices, wherein the database includes the device attributes. A communication module 230 (or means for receiving a request for a mobile device, or means for sending the recommended device list) operatively connected to the database receives a request for a mobile device from a user. The request includes user attributes, which in at least one embodiment, include job responsibilities, job level, business unit, geographic location, and/or user affiliations.

The system also includes a processor 240 that is operatively connected to the database 220 and the communication module 230. The processor 240 matches the device attributes to the user attributes to generate a recommended device list. The communication module 230 sends the recommended device list to the user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

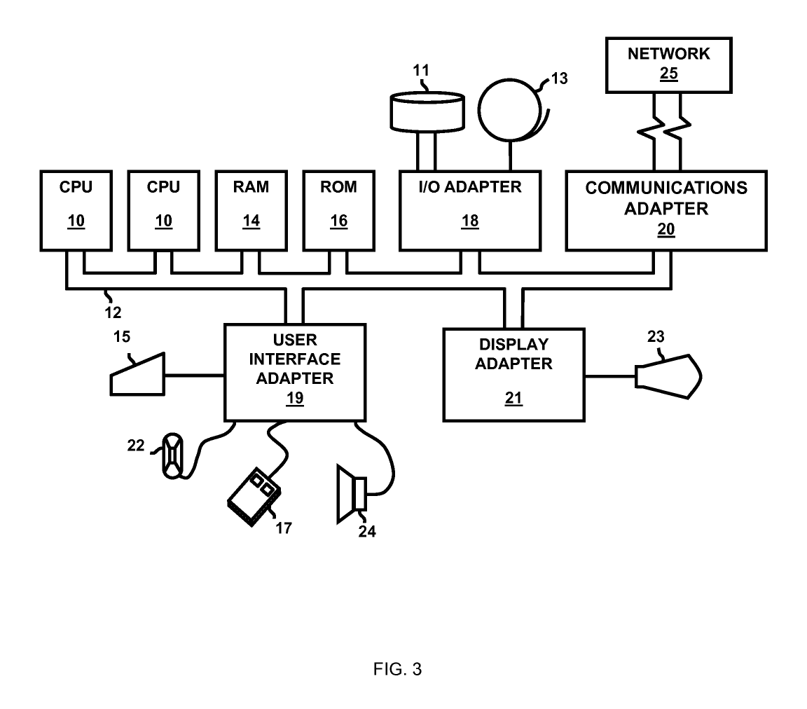

Referring now to FIG. 3, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method, including:
accumulating device metrics of a plurality of mobile devices, the device metrics including device attributes of the mobile devices, the device attributes including at least one of user tags and user quality ratings of the mobile devices;
creating a database of the mobile devices, the database including the accumulated device metrics;
receiving a request for a mobile device from a user, the request including user attributes;
generating a recommended device list with a processor, said generating of the recommended device list including matching the device attributes to the user attributes; and
sending the recommended device list to the user.

2. The method according to claim 1, wherein the device attributes include at least two of media format capabilities, codec types, operating system, Bluetooth capabilities, speakerphone capabilities, processing speed, signal strength, screen size, screen resolution, keyboard features, compatible web applications, compatible mobile applications, business affiliations, business unit affiliations, and cost.

3. The method according to claim 1, wherein the user attributes include at least one of job responsibilities, job level, business unit, geographic location, and user affiliations.

4. The method according to claim 1, wherein said accumulating of the device metrics further includes obtaining device attributes for at least one of a newly available mobile device and a mobile device satisfying a predetermined level of popularity.

5. The method according to claim 1, wherein said matching of the device attributes to the user attributes includes, for each mobile device in the database:
assigning an attribute score to at least one device attribute based on whether the device attribute matches a user attribute; and
assigning a matching score to the mobile device based on the total attribute scores for device attributes, wherein said generating of the recommended device list includes ranking the mobile devices based on the matching score.

6. The method according to claim 5, wherein said generating of the recommended device list includes only listing mobile devices that have a matching score above a predetermined threshold.

7. The method according to claim 1, further including matching the user attributes to service provider attributes to create a recommended service provider list.

8. The method according to claim 7, wherein the service provider attributes include at least one of usage restrictions, coverage area, bundling packages, voicemail capabilities, data capabilities, group rates, and cost.

9. The method according to claim 7, further including sending at least one of the recommended device list and the recommended service provider list to an interface.

10. The method according to claim 1, further including, prior to said sending of the recommended device list, confirming that the device attributes of mobile devices in the recommended device list are correct.

11. A method, including:
accumulating device metrics of a plurality of mobile devices, the device metrics including device attributes of the mobile devices;
creating a database of the mobile devices, the database including the device attributes;
receiving a request for a mobile device from a user, the request including user attributes, the user attributes including job responsibilities;
generating a recommended device list with a processor, said generating of the recommended device list including matching the device attributes to the user attributes; and
sending the recommended device list to the user.

12. The method according to claim 11, wherein the device attributes include at least two of user tags, user quality ratings of the mobile devices, media format capabilities, codec types, operating system, Bluetooth capabilities, speakerphone capabilities, processing speed, signal strength, compatible web applications, compatible mobile applications, business affiliations, business unit affiliations, and cost.

13. The method according to claim 11, wherein the user attributes include at least one of job level, business unit, geographic location, and user affiliations.

14. The method according to claim 11, wherein said accumulating of the device metrics further includes obtaining device attributes for at least one of a newly available mobile device and a mobile device satisfying a predetermined level of popularity.

15. The method according to claim 11, wherein said matching of the device attributes to the user attributes includes, for each mobile device in the database:
assigning an attribute score to at least one device attribute based on whether the device attribute matches at least one user attribute; and
assigning a matching score to the mobile device based on at least one of the total attribute scores for device attributes and the average attribute scores for device attributes, wherein said generating of the recommended device list includes ranking the mobile devices based on the matching score.

16. The method according to claim 15, wherein said assigning of said matching score includes:
assigning device weights to said device attributes; and
assigning user weights to said user attributes.

17. The method according to claim 15, wherein said generating of the recommended device list includes only listing mobile devices that have a matching score above a predetermined threshold.

18. The method according to claim 11, further including matching the user attributes to service provider attributes to create a recommended service provider list.

19. The method according to claim 18, further including sending at least one of the recommended device list and the recommended service provider list to an interface.

20. The method according to claim 11, further including, prior to said sending of the recommended device list, confirming that the device attributes of mobile devices in the recommended device list are correct.

21. A system, including:
a monitoring module for accumulating device metrics of a plurality of mobile devices, the device metrics including device attributes of the mobile devices, the device attributes including at least one of user tags and user quality ratings of the mobile devices;
a database of the mobile devices, the database including the device attributes, the database in communication with said monitoring module;
a communication module for receiving a request for a mobile device from a user, the request including user attributes; and
a processor for matching the device attributes to the user attributes to generate a recommended device list, the recommended device list being sent to the user with the communication module.

22. The system according to claim 21, wherein the device attributes include at least two of media format capabilities, codec types, operating system, Bluetooth capabilities, speakerphone capabilities, processing speed, signal strength, screen size, screen resolution, keyboard features, compatible web applications, compatible mobile applications, business affiliations, business unit affiliations, and cost, and
wherein the user attributes include at least one of job responsibilities, job level, business unit, geographic location, and user affiliations.

23. The system according to claim 21, wherein for each mobile device in the database, said processor:
assigns an attribute score to at least one device attribute based on whether the device attribute matches a user attribute; and
assigns a matching score to the mobile device based on the total attribute scores for device attributes, wherein the recommended device list is generated by ranking the mobile devices based on the matching score.

24. A system, including:
means for accumulating device metrics of a plurality of mobile devices, the device metrics including device attributes of the mobile devices, the device attributes including at least one of user tags and user quality ratings of the mobile devices;
means for storing a list of the mobile devices, said means for storing including the device attributes;
means for receiving a request for a mobile device from a user, the request including user attributes;
means for matching the device attributes to the user attributes to generate a recommended device list; and
means for sending the recommended device list to the user.

25. A computer program product, including:
a computer readable storage medium;
first program instructions to accumulate device metrics of a plurality of mobile devices, the device metrics including device attributes of the mobile devices, the device attributes including at least one of user tags and user quality ratings of the mobile devices;
second program instructions to create a database of the mobile devices, the database including the device attributes;
third program instructions to receive a request for a mobile device from a user, the request including user attributes;
fourth program instructions to generate a recommended device list with a processor, said generating of the recommended device list including matching the device attributes to the user attributes; and
fifth program instructions to send the recommended device list to the user,
wherein the first program instructions, the second program instructions, the third program instructions, the fourth program instructions, and the fifth program instructions are stored on the computer readable storage medium.
